(19) United States
(12) Patent Application Publication
(10) Pub. No.: US 2014/0185503 A1
(43) Pub. Date: Jul. 3, 2014

(54) COMMUNICATION PROTOCOL FOR WIRELESS SENSOR NETWORKS USING COMMUNICATION AND ENERGY COSTS

(71) Applicant: Tanusri Roy, Assam (IN)

(72) Inventor: Tanusri Roy, Assam (IN)

(73) Assignee: Unisys Corporation, Blue Bell, PA (US)

(21) Appl. No.: 13/847,125

(22) Filed: Mar. 19, 2013

(30) Foreign Application Priority Data
Dec. 28, 2012 (IN) 4036/DEL/2012

(51) Int. Cl. H04W 52/02; H04J 3/16

(52) U.S. Cl. CPC H04W 52/02; H04J 3/16
USPC 370/311

(57) ABSTRACT

A system, method, apparatus and software are disclosed for data communication within a wireless sensor network comprising a plurality of sensors and a base station, with the sensors organized into a plurality of clusters. Each sensor is to determine a communication cost comprising an amount of power or energy required for the sensor to communicate with all other sensors within its selected cluster, and to select a sensor having a lowest communication cost as a cluster head sensor. When the sensor is the cluster head sensor, it is to determine and transmit a TDMA data transmission schedule to the other sensors within the selected cluster, to receive and aggregate sensor data from these other sensors, to transmit a data transmission request to the base station designating an amount of aggregated data to be transmitted, and to transmit the aggregated data to the base station during a designated time interval.

### BACKGROUND OF THE INVENTION

1. Field of the Invention

The present invention generally relates to communication protocols for wireless sensor networks, and more particularly, relates to a communication protocol which utilizes clustering of sensors and further accounts for both communication and energy costs in cluster head determination for data transmission to a base station in a wireless sensor network.

2. Description of the Prior Art

Various communication protocols have been utilized in wireless sensor networks, such as a Low-Energy Adaptive Clustering Hierarchy (“LEACH”) protocol. In a LEACH protocol, a network of sensors (or sensor nodes) are divided into sub-networks referred to as “clusters”, such as on a geographical (or other) basis. Within a given cluster, one of the sensors is selected, at any given time or during any given time interval, as a “cluster head” which is utilized to listen for data which may be transmitted, to receive and collect data transmitted from the other sensors in the selected cluster, and in turn to aggregate the received sensor data of the cluster and transmit the aggregated sensor data to a centralized base station. The centralized base station receives such aggregated sensor data from multiple clusters within the wireless sensor network, and provides a centralized location where an end-user can access the data.

As a result of such additional communication requirements within such a wireless sensor network, any sensor node which is acting a cluster head will generally consume more energy than the other sensor nodes, which in turn may affect sensor node failure and the overally longevity of the wireless sensor network, such as due to battery depletion and failure. To address such energy consumption in a typical LEACH protocol, the selection of a cluster head is rotated among the sensors within the cluster to evenly distribute the energy load among the sensors in the cluster, taking into account the number of cluster heads in the network, the number of times a sensor has been a cluster head, and the residual energy left at the sensor node.

Protocols such as the LEACH protocol, however, do not take into account other factors which may be important both for overall longevity of the wireless sensor network and for accurate data transmission. Accordingly, a need remains for a communication protocol which may be deployed in a wireless sensor network which accounts for communication costs within the selected cluster, and which further accounts for communication costs within the larger wireless sensor network.

### SUMMARY OF THE INVENTION

The exemplary embodiments of the present invention provide numerous advantages. Exemplary embodiments of the sensor apparatus, method, software and system of the present disclosure include a communication cost in determination of a cluster head sensor, thereby accounting for power and energy expenditures that are incurred by each sensor, not merely accounting for remaining energy levels within the sensors. By utilizing the sensors with the lowest communication cost as the cluster head sensors, by avoiding repeated cluster head elections at predetermined time periods, and by utilizing other energy saving features such as time division multiple access (“TDMA”) and active/sleep modes for data transmission, the sensor apparatus, method and system of the present disclosure reduce the overall energy consumption of the wireless sensor network. Because of this reduction in energy consumption, the useful lifetimes of each sensor and the wireless sensor network are increased.

A representative method for data communication within a wireless sensor network is disclosed, with the wireless sensor network comprising a plurality of sensors and a base station, with the plurality of sensors organized into a plurality of clusters. The representative method comprises: within a selected cluster of the plurality of clusters, and for each sensor of the plurality of sensors, determining a communication cost, the communication cost comprising a determination of an amount of power or energy required for a sensor to communicate with all other sensors within the selected cluster; within the selected cluster, selecting a sensor having a lowest communication cost as a cluster head sensor and, for each remaining sensor within the selected cluster, transmitting a join request to the cluster head sensor; using the cluster head sensor, determining and transmitting a time division multiple access (TDMA) data transmission schedule to each remaining sensor within the selected cluster; using the cluster head sensor, receiving and aggregating sensor data from each remaining sensor within the selected cluster; using the cluster head sensor, transmitting a data transmission request to the base station designating an amount of aggregated data to be transmitted; and transmitting the aggregated data to the base station during a designated time interval.

In a representative embodiment, the communication cost further comprises a determination of an amount of power or energy required for a sensor within the selected cluster to communicate with the base station.

The representative method may further comprise: within a selected cluster of the plurality of clusters, and for each sensor of the plurality of sensors, determining an amount of residual energy of the sensor, and when the residual energy is greater than a first predetermined threshold, determining a cluster head probability that is a function of both residual energy and communication cost. When the cluster head probability is greater than a second predetermined threshold, the representative method may further comprise broadcasting a candidate cluster head message which includes a specification of the communication cost of the sensor. In addition, in a representative or exemplary embodiment, the method may also include determining an amount of residual energy of the cluster head sensor, and when the residual energy is less than a third predetermined threshold, repeating the selection step to select another sensor having the lowest communication cost as the next cluster head sensor.

In a representative or exemplary embodiment, within a selected cluster of the plurality of clusters, the method may further comprise, for each sensor of the plurality of sensors, entering an active data transmission mode during its assigned time interval of the TDMA schedule; and during the assigned time interval, transmitting sensor data and returning to a lower power, data transmission sleep mode.

In addition, in a representative or exemplary embodiment, within a selected cluster of the plurality of clusters, all data and message transmission is performed within a selected frequency band or channel of a plurality of frequency bands or channels, the selected frequency band or channel different from the frequency bands or channels utilized by all other clusters of the plurality of clusters of the wireless sensor network.

A sensor for use in a wireless sensor network is also disclosed. In a representative or exemplary embodiment, the sensor comprises: a power source; a sensing component coupled to the power source; a network interface for wireless data communication, the network interface coupled to the power source; a memory coupled to the network interface and to the power source; and a controller coupled to the memory, the network interface, the sensing component, and the power source. A representative controller is to determine a communication cost comprising an amount of power or energy required for the sensor to communicate with all other sensors within the selected cluster, to select a sensor having a lowest communication cost as a cluster head sensor within the selected cluster; when the sensor is not the cluster head sensor within the selected cluster, to transmit a join request to the cluster head sensor; and when the sensor is the cluster head sensor within the selected cluster, to determine and transmit a time division multiple access (TDMA) data transmission schedule to each remaining sensor within the selected cluster, to receive and aggregate sensor data from each remaining sensor within the selected cluster, to transmit a data transmission request to the base station designating an amount of aggregated data to be transmitted, and to transmit the aggregated data to the base station during a designated time interval.

In a representative or exemplary embodiment, the controller further is to determine the communication cost as an amount of power or energy required for the sensor within the selected cluster to communicate with the base station. In another representative or exemplary embodiment, the controller further is to determine an amount of residual energy of the power source, and when the residual energy is greater than a first predetermined threshold, to determine a cluster head probability that is a function of both the residual energy and the communication cost; when the cluster head probability is greater than a second predetermined threshold, the controller further is to broadcast a candidate cluster head message which includes a specification of the communication cost of the sensor.

In another representative or exemplary embodiment, when the sensor is the cluster head sensor within the selected cluster, the controller further is to determine an amount of residual energy of the power source, and when the residual energy is less than a third predetermined threshold, to transmit a message to the remaining sensors within the selected cluster to select another sensor having the lowest communication cost as the next cluster head sensor.

In another representative or exemplary embodiment, when the sensor is not the cluster head sensor within the selected cluster, the controller further is to enter an active data transmission mode during its assigned time interval of the TDMA schedule; and further is to transmit sensor data to the cluster head sensor and return to a lower power, data transmission sleep mode.

A representative wireless sensor network system is also disclosed, comprising: a base station and a plurality of sensors. The plurality of sensors are organized into a plurality of clusters, with each sensor within a selected cluster of the plurality of clusters. In a representative or exemplary embodiment, each sensor of the plurality of sensors is to determine a communication cost comprising an amount of power or energy required for the sensor to communicate with all other sensors within the selected cluster; to select a sensor having a lowest communication cost as a cluster head sensor within the selected cluster; when the sensor is not the cluster head sensor within the selected cluster, to transmit a join request to the cluster head sensor; and when the sensor is the cluster head sensor within the selected cluster, to determine and transmit a time division multiple access (TDMA) data transmission schedule to each remaining sensor within the selected cluster, to receive and aggregate sensor data from each remaining sensor within the selected cluster, to transmit a data transmission request to the base station designating an amount of aggregated data to be transmitted, and to transmit the aggregated data to the base station during a designated time interval.

In a representative or exemplary embodiment, the sensor further is to determine the communication cost as an amount of power or energy required for the sensor within the selected cluster to communicate with the base station. In another representative or exemplary embodiment, the sensor further is to determine an amount of residual energy of the sensor, and when the residual energy is greater than a first predetermined threshold, to determine a cluster head probability that is a function of both the residual energy and the communication cost; when the cluster head probability is greater than a second predetermined threshold, the sensor further is to broadcast a candidate cluster head message which includes a specification of the communication cost of the sensor.

In a representative or exemplary embodiment, when the sensor is the cluster head sensor within the selected cluster, the sensor further is to determine an amount of residual energy of the sensor, and when the residual energy is less than a third predetermined threshold, to transmit a message to the remaining sensors within the selected cluster to select another sensor having the lowest communication cost as the next cluster head sensor.

Also in a representative or exemplary embodiment, when the sensor is not the cluster head sensor within the selected cluster, the sensor further is to enter an active data transmission mode during its assigned time interval of the TDMA schedule, and during the assigned time interval, the sensor further is to transmit sensor data to the cluster head sensor and return to a lower power, data transmission sleep mode.

Software, namely, a non-transitory, tangible medium storing machine-readable instructions for execution by a sensor for data communication within a wireless sensor network is also disclosed. In a representative or exemplary embodiment, the non-transitory, tangible medium comprises: a first program module to determine a communication cost for the sensor within a selected cluster of the plurality of clusters, the communication cost comprising a determination of an amount of power or energy required for the sensor to communicate with all other sensors within a selected cluster, an optional second program module to determine an amount of residual energy of the sensor, and when the residual energy is greater than a first predetermined threshold, to determine a cluster head probability that is a function of both residual energy and communication cost; an optional third program module to broadcast, when the cluster head probability is greater than a second predetermined threshold, a candidate cluster head message which includes a specification of the communication cost of the sensor, a fourth program module to select, within the selected cluster, a sensor having a lowest communication cost as a cluster head sensor and, for each remaining sensor within the selected cluster, to transmit a join request to the cluster head sensor; a fifth program module, when the sensor is the cluster head sensor, to determine and transmit a time division multiple access (TDMA) data transmission schedule to each remaining sensor within the selected cluster, a sixth program module, when the sensor is the cluster head sensor, to receive and aggregate sensor data from each remaining sensor within the selected cluster; a seventh program module, when the sensor is the cluster head sensor, to transmit a data transmission request to the base station designating an amount of aggregated data to be transmitted; and an eighth program module, when the sensor is the cluster head sensor, to transmit the aggregated data to the base station during a designated time interval.

In another representative or exemplary embodiment, additional options may also include a ninth program module, when the sensor is the cluster head sensor, to determine an amount of residual energy of the cluster head sensor, and when the residual energy is less than a third predetermined threshold, to transmit a message to the remaining sensors within the selected cluster to select another sensor having the lowest communication cost as the next cluster head sensor. In another representative or exemplary embodiment, a tenth program module may be included, when the sensor is not the cluster head sensor, to enter an active data transmission mode during its assigned time interval of the TDMA schedule, transmit sensor data, and return to a lower power, data transmission sleep mode.

Numerous other advantages and features of the present invention will become readily apparent from the following detailed description of the invention and the embodiments thereof, from the claims and from the accompanying drawings.

### BRIEF DESCRIPTION OF THE DRAWINGS

The objects, features and advantages of the present invention will be more readily appreciated upon reference to the following disclosure when considered in conjunction with the accompanying drawings, wherein like reference numerals are used to identify identical components in the various views, and wherein reference numerals with alphabetic characters are utilized to identify additional types, instantiations or variations of a selected component embodiment in the various views, in which:

FIG. 1 is a block diagram illustrating an exemplary or representative wireless sensor network.

FIG. 2 is a block diagram illustrating an exemplary or representative cluster of sensors within a wireless sensor network.

FIG. 3 is a block diagram illustrating an exemplary or representative sensor apparatus.

FIG. 4, divided into FIG. 4A and FIG. 4B, is a flow chart illustrating an exemplary or representative method of or protocol for communication within a sensor cluster of a wireless sensor network.

### DETAILED DESCRIPTION OF REPRESENTATIVE EMBODIMENTS

While the present invention is susceptible of embodiment in many different forms, there are shown in the drawings and will be described herein in detail specific exemplary embodiments thereof, with the understanding that the present disclosure is to be considered as an exemplification of the principles of the invention and is not intended to limit the invention to the specific embodiments illustrated. In this respect, before explaining at least one embodiment consistent with the present invention in detail, it is to be understood that the invention is not limited in its application to the details of construction and to the arrangements of components set forth above and below, illustrated in the drawings, or as described in the examples. Methods and apparatuses consistent with the present invention are capable of other embodiments and of being practiced and carried out in various ways. Also, it is to be understood that the phraseology and terminology employed herein, as well as the abstract included below, are for the purposes of description and should not be regarded as limiting.

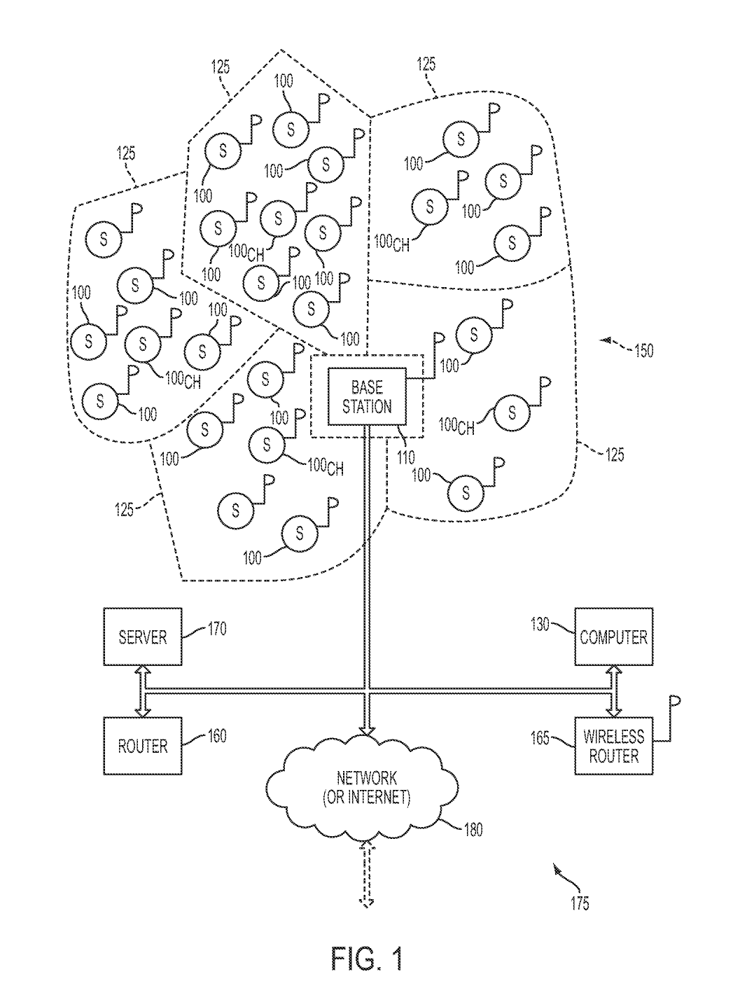

FIG. 1 is a block diagram illustrating an exemplary or representative wireless sensor network 150. As mentioned above, an exemplary or representative wireless sensor network 150 comprises a plurality of sensors 100 (also referred to as sensor nodes 100) and a base station 110. The plurality of sensors 100 are arranged or divided into groups illustrated as clusters 125, which may have any geographic or geometric shape or topology, and which may include any number of sensors 100. The number of sensors 100, the number of clusters 125, and the number of sensors 100 within a cluster 125 shown in FIG. 1 are for ease of illustration and explanation only, as a wireless sensor network 150 may have tens, hundreds or thousands of sensors (or sensor nodes) 100 grouped into any number of clusters 125, for example and without limitation. In addition, not separately illustrated, a given wireless sensor network 150 may also have more than one base station 110, with each selected or given base station 110 utilized for data reception from the sensors 100 within corresponding clusters 125 which are assigned to that given or selected base station 110. It should be noted that the terminology “sensor”, “sensor node”, and/or “node” may all be utilized equivalently to refer to a sensor 100.

Continuing to refer to FIG. 1, a plurality of cluster head sensors 100_{CH} are illustrated, one per cluster 125. Any of the sensors 100 meeting various residual energy and communication cost requirements are eligible for selection as a cluster head, and are referred to separately as a cluster head sensor 100_{CH}), as discussed in greater detail below, and which sensor 100 is designated as the cluster head sensor 100_{CH} for the cluster 125 generally will vary over time. These cluster head sensors 100_{CH} have the same sensing functions of the other sensors 100, but also have additional duties, such as to receive data from other sensors 100 within its cluster 125, and to aggregate and transmit this data to the base station 110. In another representative embodiment, the cluster head sensor 100_{CH} may also use data compression for the aggregated data, and transmit the compressed, aggregated data to the base station 110. Also as illustrated in FIG. 1, the wireless sensor network 150 may be part of a larger communication or computing system 175, and may be coupled (such as through a base station 110) in any manner (e.g., hard-wired or wirelessly) to other devices, such as for end-user access to sensor 100 data, including devices such as a computer 130, a server 170, a router 160, a wireless router 165, and to other networks (or internet) 180, also for example and without limitation.

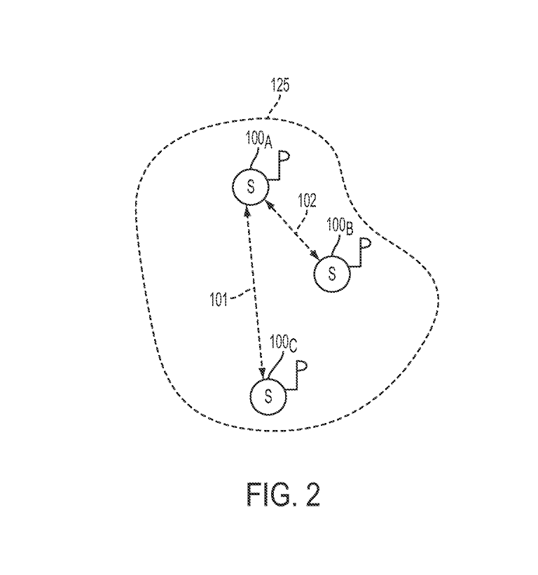

FIG. 2 is a block diagram illustrating an exemplary or representative cluster 125 of sensors 100 within a wireless sensor network 150. As illustrated, various sensors 100 are distributed throughout the cluster 125, and the geographic distances between the sensors 100 may vary considerably. In addition, other physical factors may also affect signal transmission for wireless communication between or among sensors 100, such as buildings, building features, support structures, other forms of interference and obstacles, etc. As a result, power and other energy requirements, signal-to-noise ratios and other signal transmission requirements for wireless communication between and among the sensors 100 may also vary considerably. As a comparatively simple example, higher power and greater energy consumption typically may be required for accurate and reliable communication with a sufficient signal-to-noise ratio over longer distances, illustrated in FIG. 2 using dashed line 101 for communication between sensor 100_{A} and sensor 100_{C}, compared to a lower power and lower energy consumption which typically may be required for accurate and reliable communication at that same signal-to-noise ratio over shorter distances, illustrated in FIG. 2 using dashed line 102 for communication between sensor 100_{A} and sensor 100_{B}. Those having skill in the electronic and communication arts may recognize that additional factors may also influence energy consumption and accuracy or reliability of wireless data transmission within a cluster 125.

Accordingly, as used herein, “communication cost” is the overall cost required for any sensor 100 to interact (e.g., communicate at the requisite signal-to-noise ratio) with any other sensor 100 within a cluster 125 for any reason, and may include any and all appropriate factors, such as the energy and power requirements for the requisite signal-to-noise ratio to achieve sufficiently accurate and reliable data communication. For example, sensor 100_{A} may have a comparatively lower communication cost for communication with sensor 100_{B} compared to communication with sensor 100_{C}. In an exemplary embodiment, communication cost is determined based upon the power consumption needed at the requisite signal-to-noise ratio to achieve sufficiently accurate and reliable data communication between a selected sensor 100 and all of the remaining sensors 100 within a selected cluster 125 of the wireless network 150, i.e., for each sensor 100, the communication cost is the arithmetic sum of the power consumption (at the requisite signal-to-noise ratio to achieve sufficiently accurate and reliable data communication) for the selected sensor 100 to communicate with each of the remaining sensors 100 within the selected cluster 125. In another representative embodiment, the communication cost for a given or selected sensor 100 may also include the energy or power requirements for that given or selected sensor 100 to accurately and reliably communicate or otherwise interact with the base station 110 which, for example, may be located near or far from the given or selected sensor 100.

As mentioned above and as discussed in greater detail below, in accordance with the present disclosure, within a cluster 125, communication occurs within a selected frequency band of a plurality of frequency bands (frequency division multiplexing (or multiple access) (“FDM” (or “FDMA”)), with each cluster 125 operating at a different frequency band than the other clusters 125 of the wireless network 150. Based upon both the communication cost and residual energy (i.e., the current level of energy stored or remaining) in a given sensor 100, that given or selected sensor 100 determines its probability of becoming a cluster head sensor 100_{CH} within its cluster 125. This probability is directly proportional to its residual energy and inversely proportional to its communication cost, i.e., a given or selected sensor 100 has a comparatively higher probability of becoming a cluster head sensor 100_{CH} when it has a comparatively higher residual energy and a comparatively lower communication cost. When the given or selected sensor 100 has sufficient residual energy (i.e., greater than a first predetermined threshold) and its probability of becoming a cluster head sensor 100_{CH} is greater than a second predetermined threshold, the given or selected sensor 100 will participate as a candidate in the cluster head sensor 100_{CH} selection process for its cluster 125, and will broadcast a candidate cluster head message to the other sensors 100 within the cluster 125.

This second predetermined threshold for the probability of becoming a cluster head sensor 100_{CH} may be set or determined based on a plurality of factors. In a representative embodiment, this second predetermined threshold for the probability of becoming a cluster head sensor 100_{CH} is set or determined based on the optimal value which is required for data transmission without loss. Each candidate cluster head message includes a specification or other designation of the communication cost for that given or selected sensor 100. The sensors 100 within a cluster 125 determine, for a given time period, which sensor 100 will be designated as the cluster head sensor 100_{CH} for the selected cluster 125, selecting the sensor 100 which has the lowest communication cost. (If more than one sensor 100 has the same, lowest communication cost, any of various tie-breaking methodologies may be implemented, or a round-robin selection, etc.)

Rather than automatically performing cluster head elections at predetermined time intervals, which is a comparative waste of energy and power, cluster head selection is determined only as may be actually necessary, such as depending upon the residual energy levels of the current cluster head sensor 100_{CH}. Another important feature of the present disclosure, when the residual energy of the current cluster head sensor 100_{CH} is no longer above another, third predetermined threshold, the cluster head election process is held and a new cluster head sensor 100_{CH} is selected, thereby avoiding any potential loss of data which might occur if the current cluster head sensor 100_{CH} were to fail prematurely. In an exemplary embodiment, the third predetermined threshold for residual energy for the cluster head sensor 100_{CH} is the same as the first predetermined threshold for the residual energy of any potential candidate cluster head sensor. In another exemplary embodiment, the third predetermined threshold for residual energy for the cluster head sensor 100_{CH} is greater than the first predetermined threshold for the residual energy for any potential candidate cluster head sensor, so that the current cluster head sensor 100_{CH} may participate again, at a later time, as a cluster head sensor. Also in an exemplary embodiment, a sensor 100 may continue as cluster head sensor 100_{CH} until its residual energy is no longer above this third predetermined threshold.

The selected cluster head sensor 100_{CH} then determines a transmission schedule for the other sensors 100 within the cluster 125, and transmits a message to each of the other sensors 100 with an assignment or other specification of its time slot or interval for data transmission to the cluster head sensor 100_{CH}, implementing a first level of time division multiple access (“TDMA”). This avoids data collisions and interference in data transmissions between and among the sensors 100 within a cluster 125, thereby reducing the need for data retransmissions and further providing energy and power savings within the cluster 125. This implementation of TDMA also avoids any requirement for a sensor 100 to monitor the cluster head sensor 100_{CH} channel (frequency band) for activity, further reducing energy expenditures. Additional energy and power savings are provided by providing a plurality of data transmission operating modes within a sensor 100, namely, each sensor 100 has a sleep mode for data transmission, and enters an active (or waking) mode during its assigned time interval for data transmission, thereby avoiding energy losses associated with always being in a full power mode for data transmission. (It should be noted that the power options for sensing modes may vary in any given embodiment, such as periodic or continuous sensing modes, as selected or otherwise determined by the user). In this first level of TDMA, for data transmission from the remaining sensors 100 to the cluster head sensor 100_{CH}, the specified time slots or intervals are referred to as “assigned” time slots or intervals, to distinguish them from the time slots or intervals of the second level of TDMA, for data transmission from the cluster head sensor 100_{CH} to the base station 110, discussed in greater detail below, in which the specified time slots or intervals will be referred to as “designated” time slots or intervals. Those having skill in the art will recognize that all such terminology designations are considered equivalent, with any differentiation based solely on distinguishing the two different levels of TDMA utilized herein. Those having skill in the art will also recognize that this first level of TDMA repeats with a predetermined frequency f, and with all of the assigned time slots or intervals having an overall period T, with T=1/f.

The designated cluster head sensor 100_{CH} is also responsible for aggregating sensor data communicated from all of the other sensors 100 within the cluster 125. As mentioned above, the cluster head sensor 100_{CH} may also employ data compression for this aggregated data, further reducing transmission time and corresponding energy expenditures. When the cluster head sensor 100_{CH} has data to communicate to the base station 110, it transmits a request message to the base station 110 which includes a specification or designation of the amount of data to be transmitted, such as the number of data packets to be transmitted, length of data, etc. The base station 110 then specifies or otherwise designates a time slot or interval for data transmission for this cluster head sensor 100_{CH} to the base station 110 (also implementing a second level of TDMA, as the base station 110 receives data transmissions from a plurality of cluster head sensors 100_{CH} within the wireless network 150), and then the cluster head sensor 100_{CH} transmits the aggregated data (or aggregated and compressed data) to the assigned base station 110 of the wireless network 150 during this designated time slot or interval. This also avoids data collisions and interference in data transmissions between and among the cluster head sensors 100_{CH} within the wireless network 150, thereby also reducing the need for data retransmissions and further providing energy and power savings within the wireless sensor network 150. This implementation of a second level of TDMA also avoids any requirement for a cluster head sensor 100_{CH} to monitor the base station 110 channel (frequency band) for activity, further reducing energy expenditures. In addition to selection of a cluster head sensor 100_{CH}, these additional protocol features, such as TDMA, FDM and/or FDMA, are also implemented in the representative communication protocol to diminish or minimize energy and power consumption utilized for such data communication between the sensors 100 and the cluster head sensor 100_{CH}, and between the cluster head sensor 100_{CH} and the base station 110. As generally any sensor 100 may be designated as a cluster head sensor 100_{CH}, each sensor 100 will be implemented to have this communication protocol functionality of the present disclosure, as described below.

Additional communication protocols also may be implemented. For example and without limitation, code division multiple access (“CDMA”) may also be utilized, such as for communication between the cluster head sensor 100_{CH} and the base station 110, rather than FDM or FDMA.

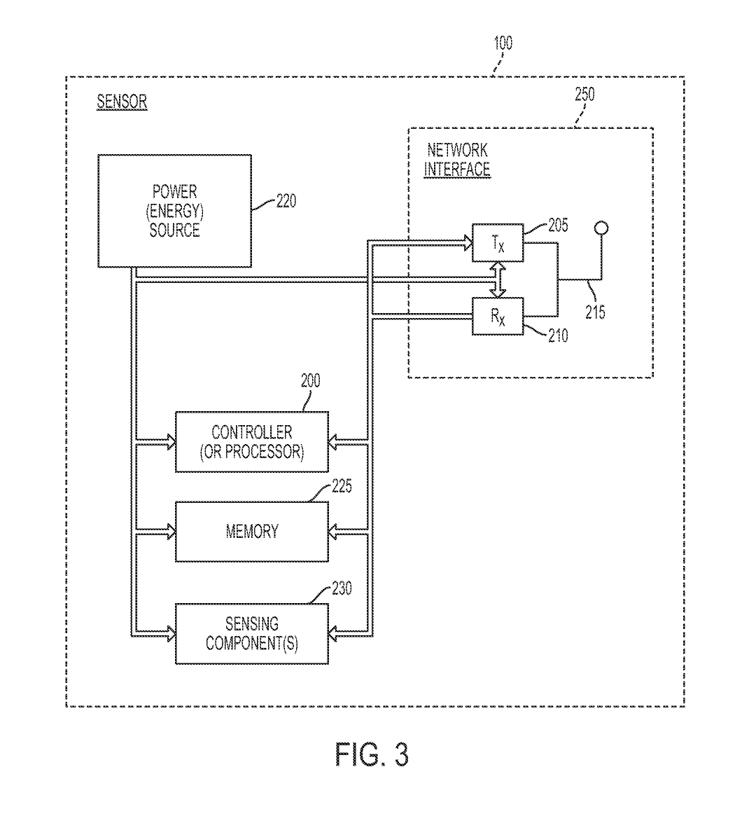

FIG. 3 is a block diagram illustrating an exemplary or representative sensor 100 apparatus. As illustrated, a sensor 100 for a wireless sensor network 150 comprises a controller (or processor) 200, a network interface 250, one or more sensing component(s) 230, a power (or energy) source 220, and a memory 225 (and if available, memory 225 also may be embodied instead as the memory which may be provided within a controller (or processor) 200). Also as illustrated, a representative network interface 250 typically comprises a data transmitter 205 and a data receiver 210 (which are typically coupled to an antenna 215), which may be implemented for any selected type of wireless communication with any other sensor 100 or a base station 110, at selected power levels, and using any selected type of communication protocol and any selected frequency band or range (e.g., TDMA, FDM or FDMA), as described above. The network interface 250 performs the various data transmission and reception functionality of the present disclosure, under the control of the controller (or processor) 200 and using memory 225, such as for data packet transmission of any data which is stored in memory 225, or to store received data in memory 225.

The sensing component(s) 230 may be embodied or implemented for any type of desired or selected sensing capability; for example and without limitation, sensing component(s) 230 may comprise components for temperature sensing, air pressure measurement, chemical detection, motion sensing, microbial detection, noise detection, other environmental sensing, etc. In addition, there may be a wide variety of the types and/or functionalities of the sensing component(s) 230 of the sensors 100 within any given wireless sensor network 150, e.g., chemical sensors 100 and motion sensors 100, also for example and without limitation.

Typically, a power (or energy) source 220 is implemented as a battery, which may be fixed or replaceable, or any other type of limited or finite power source which may be depleted with use over time. In addition, there may be a wide variety of the types of power (or energy) sources 220 of the sensors 100 within a wireless sensor network 150. (Generally, the present disclosure is applicable to wireless sensor networks 150 in which the sensors 100 have limited or finite power supplies that are depleted over time. Depending upon the circumstances and selected deployment, however, it is possible that at least for some of the sensors 100, a power (or energy) source 220 also may be implemented as an interface for coupling to an AC or DC power line, and may include a battery backup for use during a power failure from a utility company. Under circumstances such as a power failure, and for all other sensors 100 which are not coupled to an AC or DC power line, the communication protocol and concerns for communication costs and residual energy of the present disclosure are still applicable to all such wireless sensor networks 150, as the wireless sensors 100 then have a limited or finite power (or energy) source 220 capable of being depleted.)

As discussed in considerably greater detail below, a controller (or processor) 200 may be implemented using any type of electronic or other circuitry which is arranged, configured, designed, programmed or otherwise adapted to perform the communication protocol functionality described herein, such as cluster head selection, creation of data packets, data aggregation (and/or data aggregation and compression), and time division multiple access communication, for example. As the term controller or processor is used herein, a controller (or processor) 200 may include use of a single integrated circuit (“IC”), or may include use of a plurality of integrated circuits or other electronic components connected, arranged or grouped together, such as controllers, microprocessors, digital signal processors (“DSPs”), parallel processors, multiple core processors, custom ICs, application specific integrated circuits (“ASICs”), field programmable gate arrays (“FPGAs”), adaptive computing ICs, discrete electronic components, and any associated memory (such as RAM, DRAM and ROM), and other ICs and components, whether analog or digital. As a consequence, as used herein, the term controller (or processor) should be understood to equivalently mean and include a single IC, or arrangement of custom ICs, ASICs, processors, microprocessors, controllers, FPGAs, adaptive computing ICs, or some other grouping of integrated circuits or discrete electronic components which perform the functions discussed above and further discussed below, and may further include any associated memory, such as microprocessor memory or additional RAM, DRAM, SDRAM, SRAM, MRAM, ROM, FLASH, EPROM or E²PROM. A controller (or processor) (such as controller (or processor) 200), with any associated memory, may be arranged, adapted or configured (via programming, FPGA interconnection, or hard-wiring) to perform the communication protocol functionality of the present disclosure, as described herein. For example, the methodology may be programmed and stored, in a controller (or processor) 200 with its associated memory (and/or memory 225) and other equivalent components, as a set of program instructions or other code (or equivalent configuration or other program) for subsequent execution when the controller (or processor) 200 is operative (i.e., powered on and functioning). Equivalently, when the controller 120, 160 may implemented in whole or part as FPGAs, custom ICs and/or ASICs, the FPGAs, custom ICs or ASICs also may be designed, configured and/or hard-wired to implement the communication protocol methodology of the present disclosure. For example, the controller (or processor) 200 may be implemented as an arrangement of analog and/or digital circuits, controllers, microprocessors, DSPs and/or ASICs, collectively referred to as a “controller”, which are respectively hard-wired, arranged, programmed, designed, adapted or configured to implement the communication protocol functionality of the present disclosure, including possibly in conjunction with a memory 225.

A memory 225 may be embodied as any type of data storage device, such as RAM, FLASH, DRAM, SDRAM, SRAM, MRAM, FeRAM, ROM, EPROM or E²PROM, and is utilized for data storage, such as storage of sensed data awaiting transmission to a cluster head sensor 100_{CH}, storage of aggregated data from other sensors 100, and also may be utilized to store any program instructions or configurations which may be utilized by a controller (or processor) 200. More specifically, the memory 225 may be embodied in any number of forms, including within any nontransitory, machine-readable data storage medium, memory device or other storage or communication device for storage or communication of information, currently known or which becomes available in the future, including, but not limited to, a memory integrated circuit (“IC”), or memory portion of an integrated circuit (such as the resident memory within a controller (or processor) 200 or processor IC), whether volatile or non-volatile, whether removable or non-removable, including without limitation RAM, FLASH, DRAM, SDRAM, SRAM, MRAM, FeRAM, ROM, EPROM or E²PROM, or any other form of memory device, such as a magnetic hard drive, an optical drive, a magnetic disk or tape drive, a hard disk drive, other machine-readable storage or memory media such as a floppy disk, a CDROM, a CD-RW, digital versatile disk (DVD) or other optical memory, or any other type of memory, storage medium, or data storage apparatus or circuit, which is known or which becomes known, depending upon the selected embodiment. The memory 225 may store data in any way or configuration, including as various look up tables, parameters, coefficients, databases, other information and data, programs or instructions (of the software of the present invention), and other types of tables such as database tables or any other form of data repository.

As indicated above, the controller (or processor) 200 is hard-wired, configured or programmed, using software and data structures of the invention, for example, to perform the communication protocol functionality of the present disclosure. As a consequence, the system and method of the present disclosure may be embodied as software which provides such programming or other instructions, such as a set of instructions and/or metadata embodied within a nontransitory computer-readable medium, discussed above. In addition, metadata may also be utilized to define the various data structures of a look up table or a database. Such software may be in the form of source or object code, by way of example and without limitation. Source code further may be compiled into some form of instructions or object code (including assembly language instructions or configuration information). The software, source code or metadata of the present invention may be embodied as any type of code, such as C, C++, SystemC, LISA, XML, Java, Brew, SQL and its variations (e.g., SQL 99 or proprietary versions of SQL), DB2, Oracle, or any other type of programming language which performs the functionality discussed herein, including various hardware definition or hardware modeling languages (e.g., Verilog, VHDL, RTL) and resulting database files (e.g., GDSII). As a consequence, a “module”, “program module”, “software module”, “software construct” or “software”, as used equivalently herein, means and refers to any programming language, of any kind, with any syntax or signatures, which provides or can be interpreted to provide the associated functionality or methodology specified (when instantiated or loaded into a processor or computer and executed, including the controller (or processor) 200, for example). In addition, any of such program or software modules may be combined or divided in any way. For example, a larger module combining first and second functions is considered equivalent to a first module which performs the first function and a separate second module which performs the second function.

The software, metadata, or other source code of the present invention and any resulting bit file (object code, database, or look up table) may be embodied within any tangible, non-transitory storage medium, such as any of the computer or other machine-readable data storage media, as computer-readable instructions, data structures, program modules or other data, such as discussed above with respect to the memory 225, e.g., a memory IC, a floppy disk, a CDROM, a CD-RW, a DVD, a magnetic hard drive, an optical drive, or any other type of data storage apparatus or medium, as mentioned above.

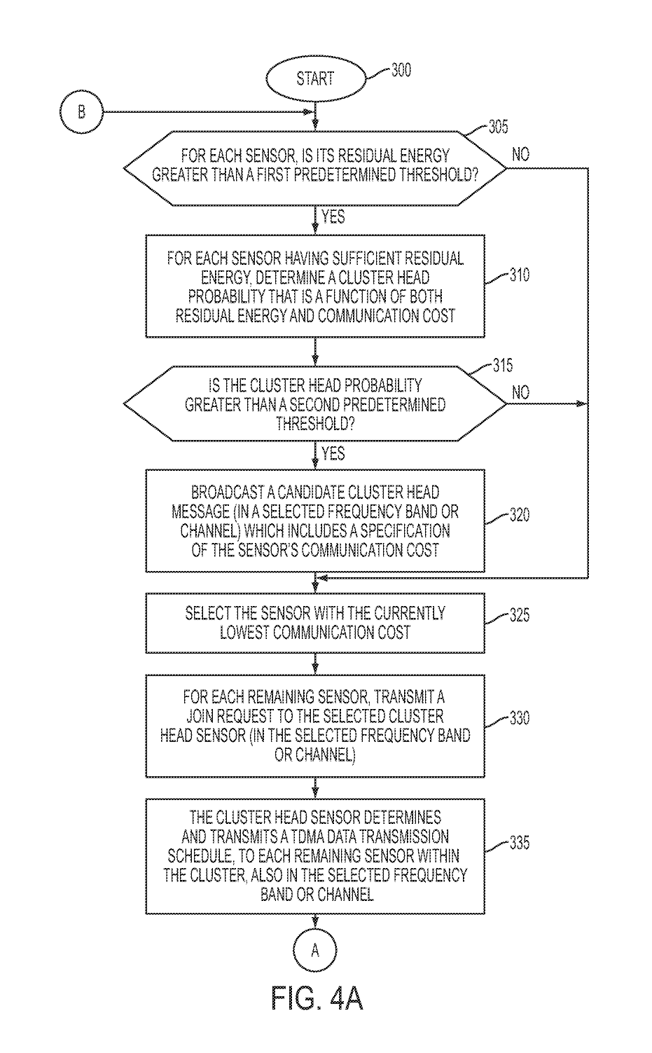

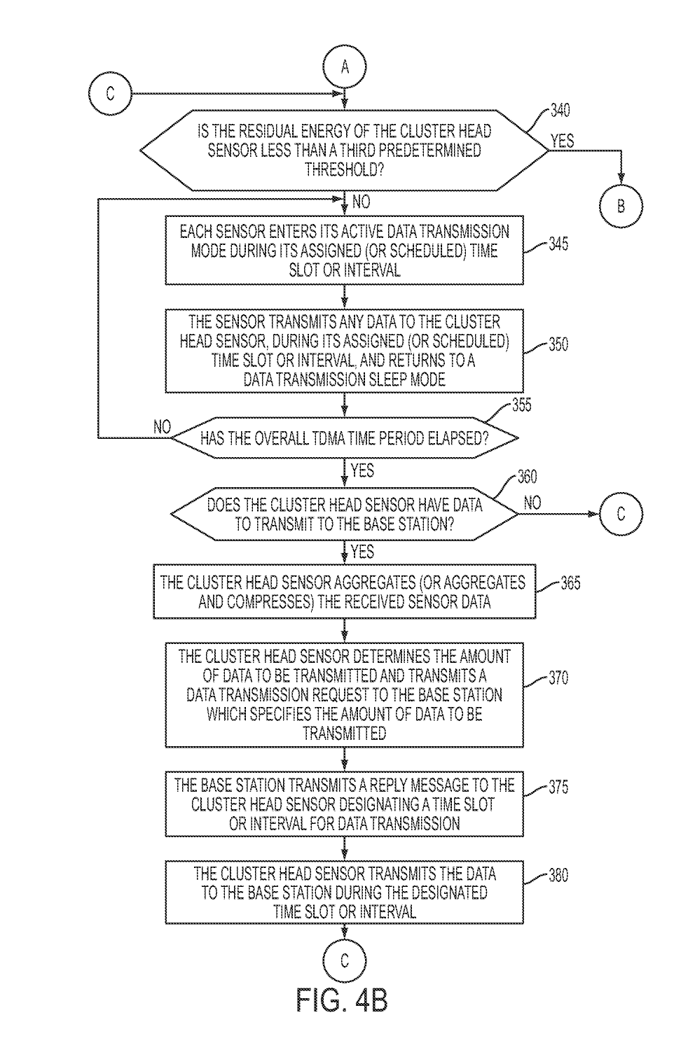

FIG. 4 is a flow chart illustrating an exemplary or representative method of or protocol for communication within a sensor cluster 125 of a wireless sensor network 150, including cluster head selection, communication between a sensor 100 and a cluster head, and communication between a cluster head within a sensor cluster 125 and a centralized base station 110 of a wireless sensor network 150, and provides a useful summary. Beginning with start step 300, each sensor 100 determines, using its controller (or processor) 200, whether its residual energy level (in its power (or energy) source 220) is greater than a first predetermined threshold, step 305, and if so, that sensor 100 determines its probability of becoming a cluster head sensor 100_{CH} within its cluster 125, based upon both its communication cost and its residual energy (i.e., the current level of energy stored or remaining in that sensor 100), step 310. As described above, this probability is directly proportional to its residual energy and inversely proportional to its communication cost. When the given or selected sensor 100 has sufficient residual energy (i.e., greater than a first predetermined threshold) (step 305) and its probability of becoming a cluster head sensor 100_{CH} is greater than a second predetermined threshold, step 315, the given or selected sensor 100 will participate as a candidate in the cluster head sensor 100_{CH} selection process for its cluster 125, and will broadcast a candidate cluster head message (using its controller (or processor) 200, memory 225, and network interface 250) in the selected frequency band or channel to the other sensors 100 within the cluster 125, step 320, including to those which do not have sufficient residual energy or a sufficiently high probability to become a cluster head. As described above, each candidate cluster head message includes a specification or other designation of the communication cost for that given or selected sensor 100. The sensors 100 within a cluster 125 determine (each using its controller (or processor) 200) which sensor 100 will be designated as the current cluster head sensor 100_{CH} for the selected cluster 125, selecting the sensor 100 which has the lowest communication cost, step 325 (which may also include any of various tie-breaking methodologies or a round-robin selection, for example and without limitation). Each of the remaining (i.e., unselected) sensors 100 within the cluster 125 then transmit a join request (using its controller (or processor) 200, memory 225, and network interface 250) to the selected cluster head sensor 100_{CH}, in the selected frequency band or channel, step 330. The selected cluster head sensor 100_{CH} then determines a transmission schedule for the other sensors 100 within the cluster 125, and transmits a message (using its controller (or processor) 200, memory 225, and network interface 250, and in the selected frequency band or channel) to each of the other sensors 100 with a designation of its assigned time slot or interval for data transmission to the cluster head sensor 100_{CH}, implementing a first level of TDMA, step 335.

In step 340, the cluster head sensor 100_{CH} determines (using its controller (or processor) 200) whether its residual energy level is less than a third predetermined threshold (which may be the same as or greater than the first predetermined threshold), and if so, returns to step 305 for selection of another cluster head sensor 100_{CH}, and otherwise proceeds to step 345. It should be noted that this determination occurs before the current cluster head sensor 100_{CH} has collected data from the other sensors 100, so that generally, no loss of data will have occurred due to a premature failure of the cluster head sensor 100_{CH}. It should also be noted that in order to return to step 305 when the residual energy is less than the third predetermined threshold, the cluster head sensor 100_{CH} generally will transmit a message to the remaining sensors 100 within the selected cluster 125 to select another sensor 100 having the lowest communication cost as the next cluster head sensor 100_{CH}. In step 345, using its controller (or processor) 200, each sensor 100 enters its active data transmission mode during its assigned time slot or interval, and in step 350, transmits any data to the cluster head sensor 100_{CH} in the selected frequency band or channel and returns to a sleep mode for data transmission (using its controller (or processor) 200, memory 225, and network interface 250). When the overall TDMA time period (T) has not completed (as determined by the cluster head sensor 100_{CH}), step 355, the method returns to steps 345 and 350, for each sensor 100 to enter its active mode and transmit any data to the cluster head sensor 100_{CH} in its assigned time interval or slot. When the overall TDMA period has been completed in step 355, the cluster head sensor 100_{CH} determines (using its controller (or processor) 200) whether it has data to transmit to the base station 110, step 360, and if not, returns to step 340.

When the cluster head sensor 100_{CH} does have data to transmit to the base station 110 in step 360, cluster head sensor 100_{CH} aggregates (or aggregates and compresses) the data, step 365, (using its controller (or processor) 200 and memory 225), storing the aggregated data in its memory 225. The cluster head sensor 100_{CH} determines how much aggregated (and/or compressed) data it has to transmit, and transmits a data transmission request to the base station 110, step 370, which includes a specification or designation of the amount of data to be transmitted, such as the number of data packets to be transmitted, length of data, etc. The base station 110 then transmits a data transmission reply message to the cluster head sensor 100_{CH} which specifies a designated time slot or interval for data transmission, implementing a second level of TDMA, step 375. The cluster head sensor 100_{CH} transmits the aggregated data (or aggregated and compressed data) to the assigned base station 110 of the wireless network 150 during this designated time slot or interval, step 380, and the method returns to step 340.

It should be noted that the communication protocol methodology illustrated in FIG. 4 operates as a continuous loop in a representative embodiment, for the wireless sensor network 150 to be operating continuously. In addition, other or additional types of messages may also be transmitted within the wireless sensor network 150, such as indicators when residual energy levels become low and one or more sensors 100 may need to be replaced or fitted with replacement batteries, or other indicators of sensor 100 failure, for example and without limitation. Those having skill in the art will also recognize that in other representative embodiments, the methodology also may be implemented to operate in a noncontinuous mode and to include any of various determination steps for the method to shut down and cease operating, as may be necessary or desirable.

Numerous advantages of the present disclosure are readily apparent. The sensor apparatus, method and system of the present disclosure include a communication cost in determination of a cluster head sensor 100, thereby accounting for power and energy expenditures that are incurred by each sensor, not merely accounting for remaining energy levels within the sensors 100. By utilizing the sensors with the lowest communication cost as the cluster head sensors, and by utilizing other energy saving features such as TDMA and active/sleep modes for data transmission, the sensor apparatus, method and system of the present disclosure reduce the overall energy consumption of the wireless sensor network 150. Because of this reduction in energy consumption, the useful lifetimes of each sensor 100 and the wireless sensor network 150 are increased.

The present disclosure is to be considered as an exemplification of the principles of the invention and is not intended to limit the invention to the specific embodiments illustrated. In this respect, it is to be understood that the invention is not limited in its application to the details of construction and to the arrangements of components set forth above and below, illustrated in the drawings, or as described in the examples. Systems, methods and apparatuses consistent with the present invention are capable of other embodiments and of being practiced and carried out in various ways.

Although the invention has been described with respect to specific embodiments thereof, these embodiments are merely illustrative and not restrictive of the invention. In the description herein, numerous specific details are provided, such as examples of electronic components, electronic and structural connections, materials, and structural variations, to provide a thorough understanding of embodiments of the present invention. One skilled in the relevant art will recognize, however, that an embodiment of the invention can be practiced without one or more of the specific details, or with other apparatus, systems, assemblies, components, materials, parts, etc. In other instances, well-known structures, materials, or operations are not specifically shown or described in detail to avoid obscuring aspects of embodiments of the present invention. In addition, the various Figures are not drawn to scale and should not be regarded as limiting.

Reference throughout this specification to “one embodiment”, “an embodiment”, or a specific “embodiment” means that a particular feature, structure, or characteristic described in connection with the embodiment is included in at least one embodiment of the present invention and not necessarily in all embodiments, and further, are not necessarily referring to the same embodiment. Furthermore, the particular features, structures, or characteristics of any specific embodiment of the present invention may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

It will also be appreciated that one or more of the elements depicted in the Figures can also be implemented in a more separate or integrated manner, or even removed or rendered inoperable in certain cases, as may be useful in accordance with a particular application. Integrally formed combinations of components are also within the scope of the invention, particularly for embodiments in which a separation or combination of discrete components is unclear or indiscernible. In addition, use of the term “coupled” herein, including in its various forms such as “coupling” or “couplable”, means and includes any direct or indirect electrical, structural or magnetic coupling, connection or attachment, or adaptation or capability for such a direct or indirect electrical, structural or magnetic coupling, connection or attachment, including integrally formed components and components which are coupled via or through another component.

Furthermore, any signal arrows in the drawings/Figures should be considered only exemplary, and not limiting, unless otherwise specifically noted. Combinations of components of steps will also be considered within the scope of the present invention, particularly where the ability to separate or combine is unclear or foreseeable. The disjunctive term “or”, as used herein and throughout the claims that follow, is generally intended to mean “and/or”, having both conjunctive and disjunctive meanings (and is not confined to an “exclusive or” meaning), unless otherwise indicated. As used in the description herein and throughout the claims that follow, “a”, “an”, and “the” include plural references unless the context clearly dictates otherwise. Also as used in the description herein and throughout the claims that follow, the meaning of “in” includes “in” and “on” unless the context clearly dictates otherwise.

The foregoing description of illustrated embodiments of the present invention, including what is described in the summary or in the abstract, is not intended to be exhaustive or to limit the invention to the precise forms disclosed herein. From the foregoing, it will be observed that numerous variations, modifications and substitutions are intended and may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

It is claimed:

1. A method for data communication within a wireless sensor network, the wireless sensor network comprising a plurality of sensors and a base station, the plurality of sensors organized into a plurality of clusters, the method comprising:
within a selected cluster of the plurality of clusters, and for each sensor of the plurality of sensors, determining a communication cost, the communication cost comprising a determination of an amount of power or energy required for a sensor to communicate with all other sensors within the selected cluster;
within the selected cluster, selecting a sensor having a lowest communication cost as a cluster head sensor and, for each remaining sensor within the selected cluster, transmitting a join request to the cluster head sensor;
using the cluster head sensor, determining and transmitting a time division multiple access (TDMA) data transmission schedule to each remaining sensor within the selected cluster,
using the cluster head sensor, receiving and aggregating sensor data from each remaining sensor within the selected cluster;
using the cluster head sensor, transmitting a data transmission request to the base station designating an amount of aggregated data to be transmitted; and
transmitting the aggregated data to the base station during a designated time interval.

2. The method of claim 1, wherein the communication cost further comprises a determination of an amount of power or energy required for a sensor within the selected cluster to communicate with the base station.

3. The method of claim 1, further comprising:
within a selected cluster of the plurality of clusters, and for each sensor of the plurality of sensors, determining an amount of residual energy of the sensor, and when the residual energy is greater than a first predetermined threshold, determining a cluster head probability that is a function of both residual energy and communication cost.

4. The method of claim 3, further comprising:
within a selected cluster of the plurality of clusters, and for each sensor of the plurality of sensors, when the cluster head probability is greater than a second predetermined threshold, broadcasting a candidate cluster head message which includes a specification of the communication cost of the sensor.

5. The method of claim 1, further comprising:
determining an amount of residual energy of the cluster head sensor, and when the residual energy is less than a third predetermined threshold, repeating the selection step to select another sensor having the lowest communication cost as the next cluster head sensor.

6. The method of claim 1, further comprising:
within a selected cluster of the plurality of clusters, and for each sensor of the plurality of sensors, entering an active data transmission mode during its assigned time interval of the TDMA schedule.

7. The method of claim 6, further comprising:
within a selected cluster of the plurality of clusters, and for each sensor of the plurality of sensors, during the assigned time interval, transmitting sensor data and returning to a lower power, data transmission sleep mode.

8. The method of claim 1, wherein within a selected cluster of the plurality of clusters, all data and message transmission is performed within a selected frequency band or channel of a plurality of frequency bands or channels, the selected frequency band or channel different from the frequency bands or channels utilized by all other clusters of the plurality of clusters of the wireless sensor network.

9. A sensor for use in a wireless sensor network, the wireless sensor network comprising a plurality of sensors and a base station, the plurality of sensors organized into a plurality of clusters, each sensor within a selected cluster of the plurality of clusters, the sensor comprising:
a power source;
a sensing component coupled to the power source;
a network interface for wireless data communication, the network interface coupled to the power source;
a memory coupled to the network interface and to the power source; and
a controller coupled to the memory, the network interface, the sensing component, and the power source, the controller to determine a communication cost comprising an amount of power or energy required for the sensor to communicate with all other sensors within the selected cluster; to select a sensor having a lowest communication cost as a cluster head sensor within the selected cluster; when the sensor is not the cluster head sensor within the selected cluster, to transmit a join request to the cluster head sensor; when the sensor is the cluster head sensor within the selected cluster, to determine and transmit a time division multiple access (TDMA) data transmission schedule to each remaining sensor within the selected cluster, to receive and aggregate sensor data from each remaining sensor within the selected cluster, to transmit a data transmission request to the base station designating an amount of aggregated data to be transmitted, and to transmit the aggregated data to the base station during a designated time interval.

10. The sensor of claim 9, wherein the controller further is to determine the communication cost as an amount of power or energy required for the sensor within the selected cluster to communicate with the base station.

11. The sensor of claim 9, wherein the controller further is to determine an amount of residual energy of the power source, and when the residual energy is greater than a first predetermined threshold, to determine a cluster head probability that is a function of both the residual energy and the communication cost.

12. The sensor of claim 11, wherein when the cluster head probability is greater than a second predetermined threshold, the controller further is to broadcast a candidate cluster head message which includes a specification of the communication cost of the sensor.

13. The sensor of claim 9, wherein when the sensor is the cluster head sensor within the selected cluster, the controller further is to determine an amount of residual energy of the power source, and when the residual energy is less than a third predetermined threshold, to transmit a message to the remaining sensors within the selected cluster to select another sensor having the lowest communication cost as the next cluster head sensor.

14. The sensor of claim 9, wherein when the sensor is not the cluster head sensor within the selected cluster, the controller further is to enter an active data transmission mode during its assigned time interval of the TDMA schedule.

15. The sensor of claim 14, wherein during the assigned time interval, the controller further is to transmit sensor data to the cluster head sensor and return to a lower power, data transmission sleep mode.

16. The sensor of claim 1, wherein within a selected cluster of the plurality of clusters, the network interface is to transmit all data and messages within a selected frequency band or channel of a plurality of frequency bands or channels, the selected frequency band or channel different from the frequency bands or channels utilized in all other clusters of the plurality of clusters of the wireless sensor network.

17. A wireless sensor network system comprising:
a base station; and
a plurality of sensors, the plurality of sensors organized into a plurality of clusters, each sensor within a selected cluster of the plurality of clusters, each sensor of the plurality of sensors to determine a communication cost comprising an amount of power or energy required for the sensor to communicate with all other sensors within the selected cluster; to select a sensor having a lowest communication cost as a cluster head sensor within the selected cluster; when the sensor is not the cluster head sensor within the selected cluster, to transmit a join request to the cluster head sensor; when the sensor is the cluster head sensor within the selected cluster, to determine and transmit a time division multiple access (TDMA) data transmission schedule to each remaining sensor within the selected cluster, to receive and aggregate sensor data from each remaining sensor within the selected cluster, to transmit a data transmission request to the base station designating an amount of aggregated data to be transmitted, and to transmit the aggregated data to the base station during a designated time interval.

18. The system of claim 17, wherein the sensor further is to determine the communication cost as an amount of power or energy required for the sensor within the selected cluster to communicate with the base station.

19. The system of claim 17, wherein the sensor further is to determine an amount of residual energy of the sensor, and when the residual energy is greater than a first predetermined threshold, to determine a cluster head probability that is a function of both the residual energy and the communication cost.

20. The system of claim 19, wherein when the cluster head probability is greater than a second predetermined threshold, the sensor further is to broadcast a candidate cluster head message which includes a specification of the communication cost of the sensor.

21. The system of claim 17, wherein when the sensor is the cluster head sensor within the selected cluster, the sensor further is to determine an amount of residual energy of the sensor, and when the residual energy is less than a third predetermined threshold, to transmit a message to the remaining sensors within the selected cluster to select another sensor having the lowest communication cost as the next cluster head sensor.

22. The system of claim 17, wherein when the sensor is not the cluster head sensor within the selected cluster, the sensor further is to enter an active data transmission mode during its assigned time interval of the TDMA schedule.

23. The system of claim 22, wherein during the assigned time interval, the sensor further is to transmit sensor data to the cluster head sensor and return to a lower power, data transmission sleep mode.

24. The system of claim 17, wherein within a selected cluster of the plurality of clusters, each sensor is to transmit all data and messages within a selected frequency band or channel of a plurality of frequency bands or channels, the selected frequency band or channel different from the frequency bands or channels utilized by all other clusters of the plurality of clusters of the wireless sensor network.

25. A non-transitory, tangible medium storing machine-readable instructions for execution by a sensor for data communication within a wireless sensor network, the wireless sensor network comprising a plurality of sensors and a base station, the plurality of sensors organized into a plurality of clusters, the non-transitory, tangible medium comprising:
a first program module to determine a communication cost for the sensor within a selected cluster of the plurality of clusters, the communication cost comprising a determination of an amount of power or energy required for the sensor to communicate with all other sensors within a selected cluster;
a second program module to determine an amount of residual energy of the sensor, and when the residual energy is greater than a first predetermined threshold, to determine a cluster head probability that is a function of both residual energy and communication cost;
a third program module to broadcast, when the cluster head probability is greater than a second predetermined threshold, a candidate cluster head message which includes a specification of the communication cost of the sensor;
a fourth program module to select, within the selected cluster, a sensor having a lowest communication cost as a cluster head sensor and, for each remaining sensor within the selected cluster, to transmit a join request to the cluster head sensor;
a fifth program module, when the sensor is the cluster head sensor, to determine and transmit a time division multiple access (TDMA) data transmission schedule to each remaining sensor within the selected cluster;
a sixth program module, when the sensor is the cluster head sensor, to receive and aggregate sensor data from each remaining sensor within the selected cluster;
a seventh program module, when the sensor is the cluster head sensor, to transmit a data transmission request to the base station designating an amount of aggregated data to be transmitted;
an eighth program module, when the sensor is the cluster head sensor, to transmit the aggregated data to the base station during a designated time interval;
a ninth program module, when the sensor is the cluster head sensor, to determine an amount of residual energy of the cluster head sensor, and when the residual energy is less than a third predetermined threshold, to transmit a message to the remaining sensors within the selected cluster to select another sensor having the lowest communication cost as the next cluster head sensor; and
a tenth program module, when the sensor is not the cluster head sensor, to enter an active data transmission mode during its assigned time interval of the TDMA schedule, transmit sensor data, and return to a lower power, data transmission sleep mode.
